(19) United States
(12) Patent Application Publication
(10) Pub. No.: US 2011/0260883 A1
(43) Pub. Date: Oct. 27, 2011

(54) LIGHT EMITTING DIODE MODULE WITH CONTROLLABLE LUMINOSITY

(75) Inventor: Chung-Hung Yu, Taipei (TW)

(73) Assignee: ADVANCED-CONNECTEK INC., Taipei (TW)

(21) Appl. No.: 13/091,312

(22) Filed: Apr. 21, 2011

(30) Foreign Application Priority Data
Apr. 22, 2010 (TW) 099112739

(51) Int. Cl. G09F 9/33

(52) U.S. Cl. 340/815.45

(57) ABSTRACT

The invention discloses a light emitting diode module with controllable luminosity, comprising a light emitting diode (LED) chip, a first switching unit, and a processor. The LED chip is electrically connected to a protective resistor, and the protective resistor is provided to avoid the LED chip from being burned. The first switching unit is electrically connected to a first switching resistor, and the first switching unit and the first switching resistor are in parallel to the protective resistor. The processor is provided to receive a switching signal and is electrically connected to the first switching unit, and the processor controls the first switching unit to be in a connection status or in an open status according to the switching signal, thus changing the total resistance to control the luminosity of the LED.

### FIELD OF THE INVENTION

The present invention relates to a light emitting diode module with controllable luminosity, and particularly to controlling luminosity with parallel resistors.

### BACKGROUND

In either industrial or general living needs, a general person with no light source in a dark place or at night would use a flashlight to provide sufficient light for activities and work. However, the flashlights are general handheld type for convenient control of the light source for projection, and inconvenience occurs when both hands are required in the activities or work being performed. Inventions generated from the concepts of headlights on the industrial protection helmets are thus provided with the light emitting device on the glasses for convenient light use.

In recent years, lamps using light emitting diodes (LEDs) as the light sources are developed rapidly due to the advantages of high luminosity, power saving, environment-friendly, and long life span. Nowadays LEDs gradually replace traditional light bulbs and are widely used as the light emitting devices in the lamps.

There are two conventional methods to control the luminosity. One is to control the spatial luminosity with the number of light bulbs, and the other is to use a light adjuster to adjust the output voltage and current to control the lightness of the light bulbs. The first method is widely used by most users to control the luminosity with the number of light bulbs. In this way, however, the light bulbs always work under the highest efficiency, and the life span of the lamps would be reduced, thus creating inconvenience for the users. The second method uses the light adjuster to control the lightness by adjusting the output voltage and current, which controls the luminosity and extends the life span of the light bulbs, and is thus welcomed by the users. In this method, however, additional circuits are generally required and cost would be increased.

In response to the problems of the conventional arts, with research and practical experience, the inventor provides a LED module with controllable luminosity to solve the above-mentioned defects.

### SUMMARY OF THE INVENTION

In view of the problems of the conventional arts, an objective of the present invention is to provide a light emitting diode module with controllable luminosity.

To achieve the foregoing objectives of the invention, the invention provides a light emitting diode module with controllable luminosity, which comprises a light emitting diode (LED) chip, a first switching unit, and a processor. The LED chip is electrically connected to a protective resistor, and the protective resistor is provided to avoid the LED chip from being burned. The first switching unit is electrically connected to a first switching resistor, and the first switching unit and the first switching resistor are in parallel to the protective resistor. The processor is provided to receive a switching signal and is electrically connected to the first switching unit, and the processor controls the first switching unit to be in a connection status or in an open status according to the switching signal, thus changing the total resistance to control the luminosity of the LED.

As disclosed above, the LED module of the present invention has one or more advantages as follows:

(1) The LED module extends the life span of the LED chip.

(2) The LED module is simply designed and should not increase the cost.

To improve understanding of the invention, the techniques employed by the present invention to achieve the foregoing objectives, characteristics and effects thereof are described hereinafter by way of examples with reference to the accompanying drawings.

### BRIEF DESCRIPTION OF THE DRAWINGS

FIG. 1 is a first schematic view of a LED module of the first embodiment of the present invention;

FIG. 2 is a second schematic view of a LED module of the first embodiment of the present invention;

FIG. 3 is a first schematic view of a LED module of the second embodiment of the present invention;

FIG. 4 is a second schematic view of a LED module of the second embodiment of the present invention;

FIG. 5 is a third schematic view of a LED module of the second embodiment of the present invention;

FIG. 6 is a fourth schematic view of a LED module of the second embodiment of the present invention; and

FIG. 7 is a schematic view of a LED module of the third embodiment of the present invention.

### DETAILED DESCRIPTION OF THE INVENTION

The techniques employed by the LED module of the present invention to achieve the foregoing objectives, characteristics and effects thereof are described hereinafter by way of examples with reference to the accompanying drawings. For better understanding, the same elements in different embodiments are referred to and denoted by the same numerals.

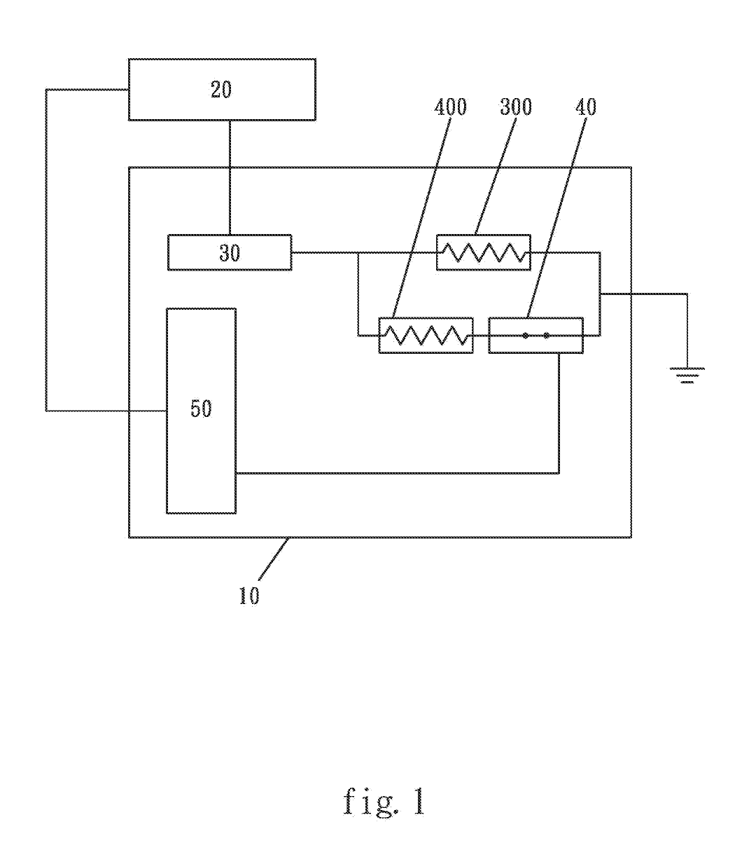

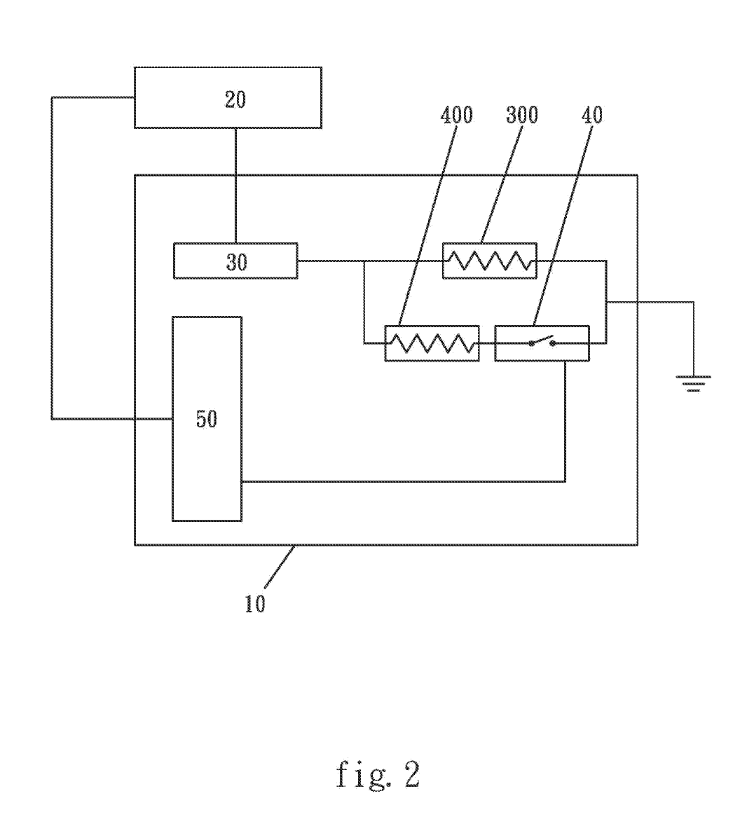

Referring to FIG. 1 and FIG. 2, FIG. 1 is a first schematic view of a LED module of the first embodiment of the present invention, and FIG. 2 is a second schematic view of a LED module of the first embodiment of the present invention. In the figures, the LED module 20 is supplied electricity by a power source 20, and the LED module 20 comprises a LED chip 30, a protective resistor 300, a first switching unit 40, a first switching resistor 400, and a processor 50.

The LED chip 30 is provided to provide light. The LED chip 30 is electrically connected to the protective resistor 300, and the protective resistor 300 is provided to avoid the LED chip 30 from being burned.

The first switching unit 40 and the first switching resistor 400 are electrically connected in series connection, and the first switching unit 40 and the first switching resistor 400 are in parallel to the protective resistor 300. The first switching unit 40 may be formed in a connection status or an open status to change the total equivalent resistance of the whole LED module 10, thus changing the current or voltage passing through the LED chip 30 and changing the luminosity of the LED chip 30. The first switching unit 40 can be preferably metal oxide semiconductors (MOS).

The processor 50 is electrically connected respectively to the power source 20 and to the first switching unit 40. The processor 50 is provided to receive a switching signal, and sends out instructions to control the first switching unit 40 to be in a connection status or in an open status according to the switching signal, thus changing the total resistance of the LED module 10 and generating a variety of different luminosity with the LED chip 30. The processor 50 can be a microcontroller unit (MCU).

In this embodiment, the switching signal can be a pulse voltage generated by switching off and then turning on of the power source 20. The pulse voltage is generally higher than the voltage provided when the power source 20 is in stable operation. Therefore, when the processor 50 receives the high pulse voltage, it sends out a signal to control the status of the first switching unit 40, thus changing the total resistance of the LED chip 30.

When a user activates the power source 20, the LED chip 30 starts to operate. At this time, the processor 50 sets the predetermined status of the first switching unit 40 as the connection status. Under the connection status, the equivalent resistance between the LED chip 30 and the ground terminal is the resistance of the protective resistor 300 in parallel to the first switching resistor 400. Thus, the LED chip 30 is in higher luminosity.

When the user turns the power source 20 off and reactivates the power source within a predetermined time interval, the processor 50 receives the high voltage switching signal to control the first switching unit 40 to switch from the connection status to the open status. At this time, the equivalent resistance is the resistance of the protective resistor 300. Thus, the current passing through the LED chip 30 is reduced, and luminosity is reduced. To have it to return to high luminosity, the user may turn the power source 20 off and reactivate the power source to return the first switching unit 40 back to the connection status, thus reducing the equivalent resistance and returning the LED chip 30 to the high luminosity.

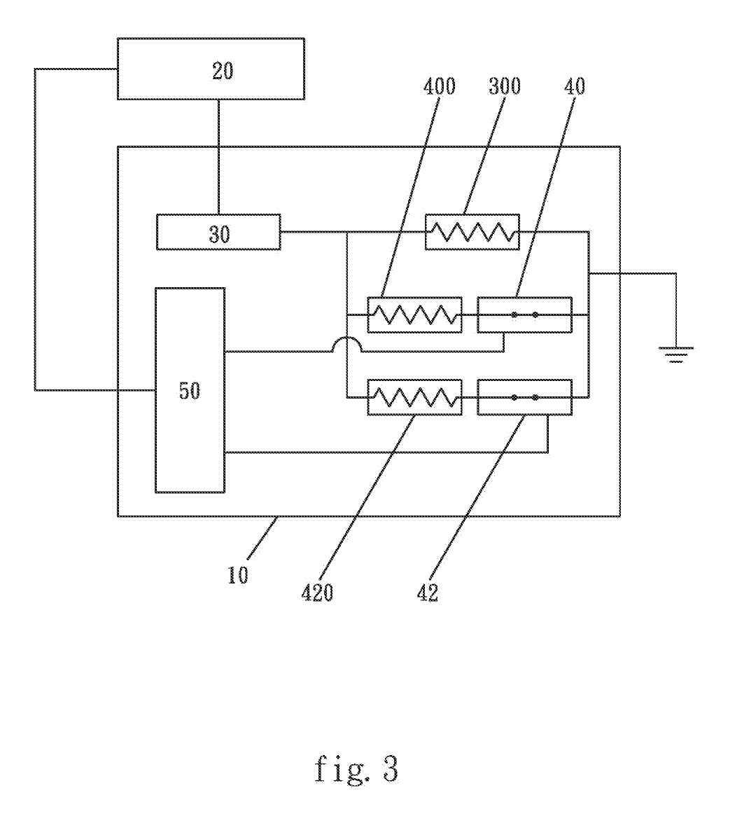

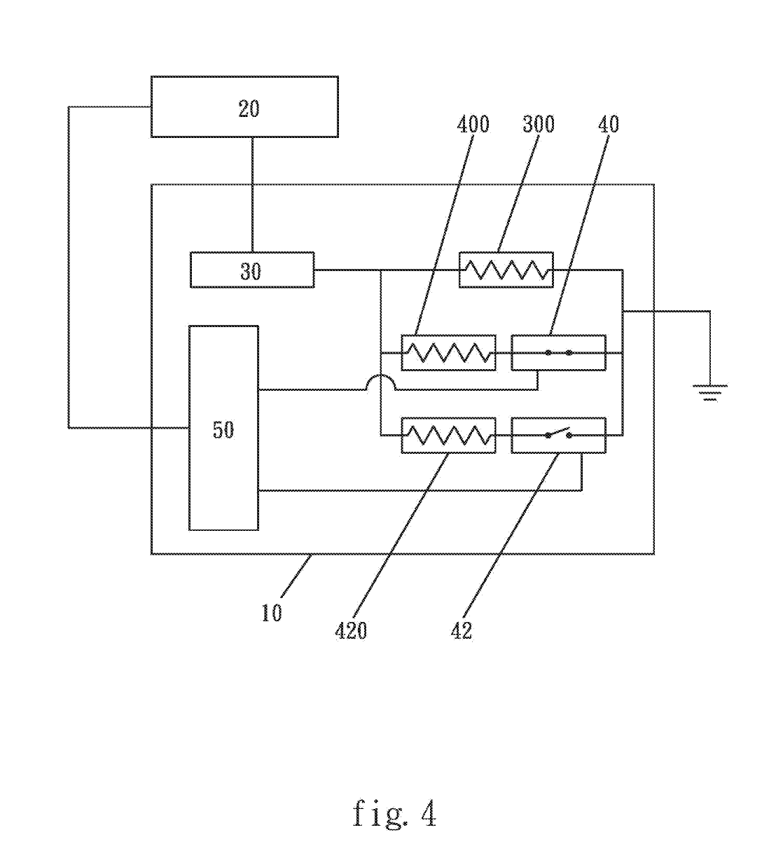

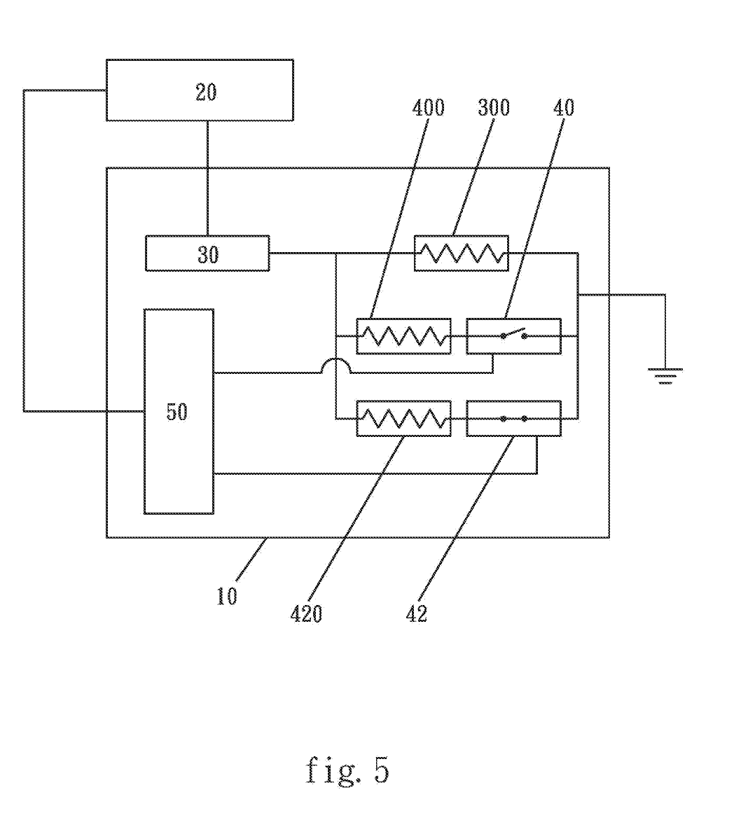

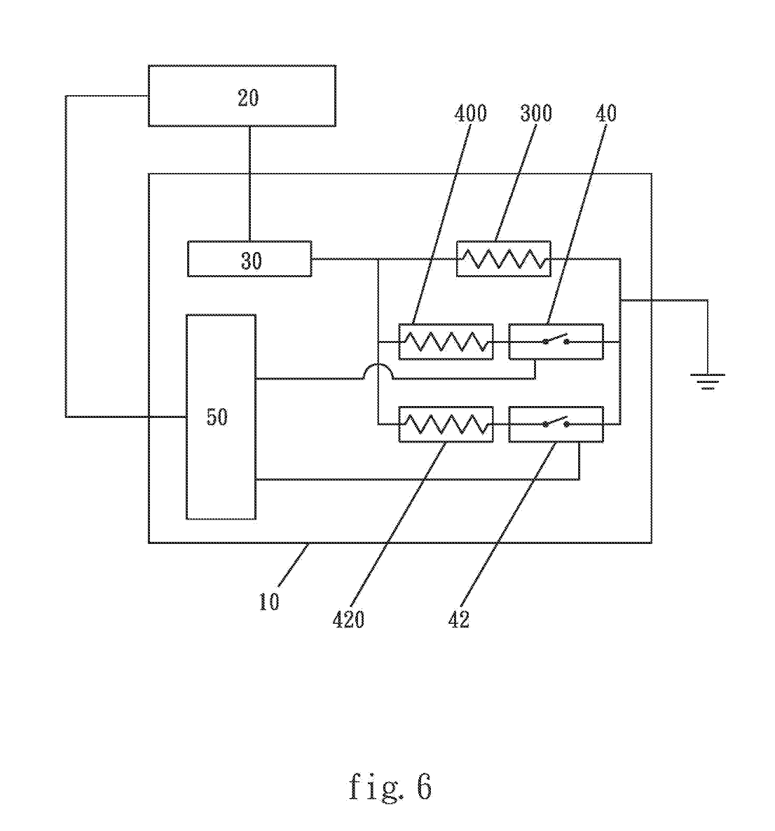

Referring to FIG. 3 to FIG. 6 and FIG. 1, FIG. 3 is a first schematic view of a LED module of the second embodiment of the present invention, FIG. 4 is a second schematic view of a LED module of the second embodiment of the present invention, FIG. 5 is a third schematic view of a LED module of the second embodiment of the present invention, and FIG. 6 is a fourth schematic view of a LED module of the second embodiment of the present invention. In the figures, the LED module 20 is supplied electricity by a power source 20, and the LED module 20 comprises a LED chip 30, a protective resistor 300, a first switching unit 40, a first switching resistor 400, a second switching unit 42, a second switching resistor 420, and a processor 50.

The LED chip 30 is provided to provide light. The LED chip 30 is electrically connected to the protective resistor 300, and the protective resistor 300 is provided to avoid the LED chip 30 from being burned. In this embodiment, the resistance of the protective resistor 300 is 20 Ω.

The first switching unit 40 and the first switching resistor 400 are electrically connected in series connection, and the first switching unit 40 and the first switching resistor 400 are in parallel to the protective resistor 300. The first switching unit 40 may be formed in a connection status or an open status to change the total equivalent resistance of the whole LED module 10, thus changing the current or voltage passing through the LED chip 30 and changing the luminosity of the LED chip 30. The first switching unit 40 can be preferably metal oxide semiconductors (MOS). In this embodiment, the resistance of the first switching resistor 400 is 80 Ω.

The second switching unit 42 and the second switching resistor 420 are electrically connected in series connection, and the second switching unit 42 and the second switching resistor 420 are in parallel to the protective resistor 300 and the first switching resistor 400. The second switching unit 42 may be formed in a connection status or an open status to change the total equivalent resistance of the whole LED module 10, thus changing the current or voltage passing through the LED chip 30 and changing the luminosity of the LED chip 30. The second switching unit 42 can also be preferably metal oxide semiconductors (MOS). In this embodiment, the resistance of the second switching resistor 420 is 40 Ω.

The processor 50 is electrically connected respectively to the power source 20, to the first switching unit 40, and to the second switching unit 42. The processor 50 is provided to receive a switching signal, and sends out instructions to control the first switching unit 40 or the second switching unit 42 to be in a connection status or in an open status according to the switching signal, thus changing the total resistance of the LED module 10 and generating a variety of different luminosity with the LED chip 30. The processor 50 can be a microcontroller unit (MCU).

In this embodiment, the switching signal can be a pulse voltage generated by switching off and then turning on of the power source 20. The pulse voltage is generally higher than the voltage provided when the power source 20 is in stable operation. Therefore, when the processor 50 receives the high pulse voltage, it sends out a signal to control the status of the first switching unit 40 or the second switching unit 42, thus changing the total resistance of the LED chip 30.

When a user activates the power source 20, the LED chip 30 starts to operate. At this time, the processor 50 sets the predetermined status of the first switching unit 40 and the second switching unit 42 as the connection status. Under the connection status, the equivalent resistance between the LED chip 30 and the ground terminal is the resistance of the protective resistor 300 in parallel to the first switching resistor 400 and the second switching resistor 420. Thus, the LED chip 30 has a resistance of 11.5Ω, and is in the highest luminosity.

When the user turns the power source 20 off and reactivates the power source within a predetermined time interval, the processor 50 receives the high voltage switching signal to control the first switching unit 40 to switch from the connection status to the open status. At this time, the equivalent resistance is the equivalent resistance of the protective resistor 300 in parallel to the second switching resistor 420, which is increased to about 13Ω. Thus, the current passing through the LED chip 30 is reduced, and luminosity is reduced.

When the user again turns the power source 20 off and reactivates the power source within the predetermined time interval, the processor 50 again receives the high voltage switching signal to control the first switching unit 40 to switch from the open status to the connection status, and to control the second switching unit 42 to switch from the connection status to the open status. At this time, the equivalent resistance is the equivalent resistance of the protective resistor 300 in parallel to the first switching resistor 400, which is increased to about 16Ω. Thus, the current passing through the LED chip 30 is further reduced, and luminosity is further reduced.

When the user again turns the power source 20 off and reactivates the power source within the predetermined time interval, the processor 50 again receives the high voltage switching signal to control both the first switching unit 40 and the second switching unit 42 to be in the open status. At this time, the current only passes through the protective resistor 300, and the equivalent resistance is thus 20Ω. Thus, the current passing through the LED chip 30 is reduced to the lowest to generate the lowest luminosity.

Finally, to have the light to return to high luminosity, the user may turn the power source 20 off and reactivate the power source to return the first switching unit 40 and the second switching unit 42 back to the connection status, thus reducing the equivalent resistance and returning the LED chip 30 to the highest luminosity in a loop mode.

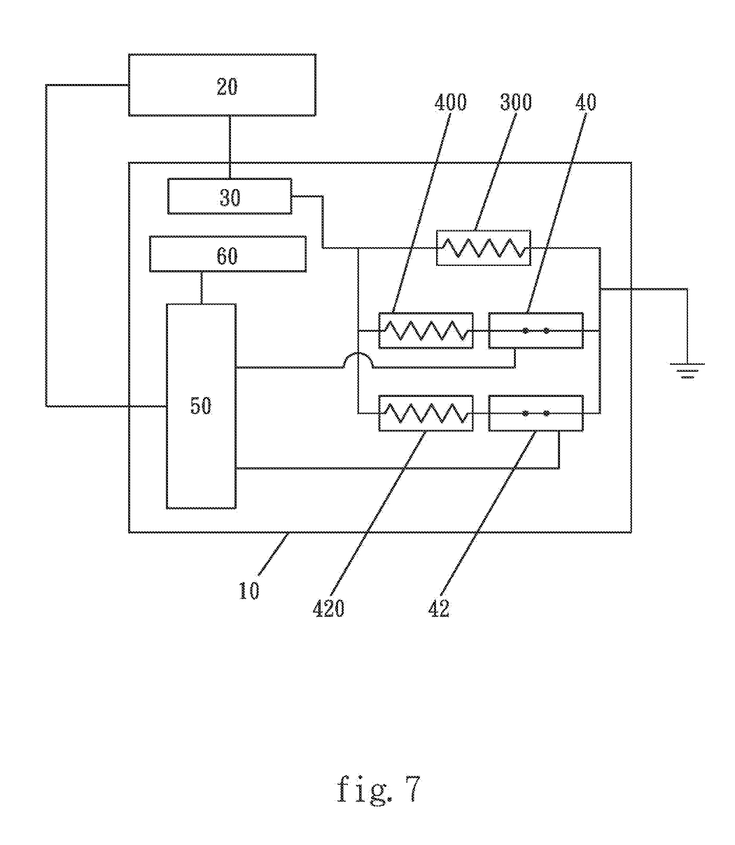

Referring to FIG. 7, which is a schematic view of a LED module of the third embodiment of the present invention. In this embodiment, only features different from the second embodiment would be disclosed, and descriptions of similar features would be eliminated. In the figures, the LED module 20 further comprises a wireless receiver 60, and the wireless receiver 60 is electrically connected directly to the processor 50. When a user wants to change the luminosity of the LED chip 30, the user sends a wireless signal to the wireless receiver 60, and the wireless receiver 60 generates the switching signal and sends to the processor 50. The processor 50 then controls the first switching unit 40 or the second switching unit 42 to be in a connection status or in an open status according to the switching signal, thus changing the total resistance of the LED module 10 and the luminosity with the LED chip 30.

The preferred embodiments of the present invention have been disclosed in the examples to show the applicable value in the related industry. However the examples should not be construed as a limitation on the actual applicable scope of the invention, and as such, all modifications and alterations without departing from the spirits of the invention and appended claims shall remain within the protected scope and claims of the invention.

What is claimed is:

1. A light emitting diode module with controllable luminosity, comprising:
a light emitting diode chip electrically connected to a protective resistor;
a first switching unit in series to and electrically connected to a first switching resistor, the first switching unit and the first switching resistor being in parallel to the protective resistor; and
a processor to receive a switching signal, the processor being electrically connected to the first switching unit;
wherein the processor controls the first switching unit to be in a connection status or in an open status according to the switching signal.

2. The light emitting diode module with controllable luminosity as claimed in claim 1, wherein the light emitting diode module is supplied electricity by a power source.

3. The light emitting diode module with controllable luminosity as claimed in claim 2, wherein the switching signal is a pulse voltage generated by switching of the power source.

4. The light emitting diode module with controllable luminosity as claimed in claim 1, further comprising a wireless receiver electrically connected to the processor, the wireless receiver receiving a wireless signal to generate the switching signal for the processor.

5. The light emitting diode module with controllable luminosity as claimed in claim 1, further comprising a second switching unit and a second switching resistor, the second switching unit and the second switching resistor being connected in series, and the second switching unit and the second switching resistor being in parallel to the protective resistor.

6. The light emitting diode module with controllable luminosity as claimed in claim 5, wherein the processor controls the second switching unit to be in a connection status or in an open status according to the switching signal.

7. The light emitting diode module with controllable luminosity as claimed in claim 5, wherein the first switching unit and the second switching unit are metal oxide semiconductors (MOS).

8. The light emitting diode module with controllable luminosity as claimed in claim 1, wherein the processor is a microcontroller unit (MCU).
